(19) United States
(12) Patent Application Publication
(10) Pub. No.: US 2017/0153484 A1
(43) Pub. Date: Jun. 1, 2017

(54) DISPLAY DEVICE AND FIXING FRAME THEREOF

(71) Applicants: Le Holdings (Beijing) Co., Ltd., Beijing (CN); Le Shi Zhi Xin Electronic Technology (Tianjin) Limited, Tianjin (CN)

(72) Inventor: Min MENG, Tianjin (CN)

(21) Appl. No.: 15/242,592

(22) Filed: Aug. 21, 2016

Related U.S. Application Data
(63) Continuation of application No. PCT/CN2016/085432, filed on Jun. 12, 2016.

(30) Foreign Application Priority Data
Nov. 27, 2015 (CN) 201520970762.4

(51) Int. Cl. G02F 1/1333

(52) U.S. Cl. CPC G02F 1/133308; G02F 2001/133317; G02F 2001/133314; G02F 2201/465; G02F 2201/46

(57) ABSTRACT

Disclosed is a display device and a fixing frame thereof. The display device includes: a liquid crystal glass, a middle frame, a rear shell and a side frame, the integral structure and the middle frame fixing the liquid crystal glass; wherein the side frame is a metal side frame, the metal side frame having an L-shaped cross section, an L-shaped long side of the metal side frame being fixed to a side wall of the rear shell via a screw to form a detachable integral structure; and the middle frame is fixed to the side wall of the rear shell, and the liquid crystal glass is fixed between an L-shaped short side of the metal side frame and the middle frame. According to the embodiments of the present application, an L-shaped metal frame having a higher strength is employed to fix a liquid crystal glass, thereby providing a more sightly and secure fixing frame.

### CROSS REFERENCE TO RELATED APPLICATIONS

This application is a continuation of International Application No. PCT/CN2016/085432, filed on Jun. 12 2016, which claims priority to Chinese Patent Application No. CN 201520970762.4, filed on Nov. 27 2015, the entire contents of both are incorporated herein by reference in their entireties.

### FIELD OF TECHNOLOGY

The disclosure relates to the field of display technologies, and more particularly, to a display device and a fixing frame thereof.

### BACKGROUND

With the improvement of people's living standards, electrical appliances used by people have transformed from original functional ones to those with sightly appearance. Further, people are imposing higher and higher requirements on video watching devices such as televisions.

At present, in the traditional television industry, most televisions employ plastic side frames, which form an integral structure with rear shells by means of snap-fit or the like fixing manners. During implementation of the present application, the inventors have identified that the related art is subjected to at least the following problems: such a design, although low in cost, is subjected to restrictions in implementation of the narrow side frame and structure strength due to restrictions on the plastic member molding thickness and the snap-fit structure. In addition, nowadays television users have higher and higher requirements on the appearance of the televisions, and are no longer satisfied with the surface feeling of the plastic frames.

Therefore, it is a technical problem to be urgently solved as how to provide a more sightly display device and fixing frame thereof.

### SUMMARY

In view of the above, embodiments of the present application provide a display device and a fixing frame thereof, to solve or partially solve the above technical problem.

An embodiment of the present application provides a display device, including: a liquid crystal glass, a middle frame, a rear shell and a side frame, the side frame and the rear shell forming an integral structure, the integral structure and the middle frame fixing the liquid crystal glass; wherein

the side frame is a metal side frame, the metal side frame having an L-shaped cross section, an L-shaped long side of the metal side frame being fixed to a side wall of the rear shell via a screw to form a detachable integral structure; and

the middle frame is fixed to the side wall of the rear shell, and the liquid crystal glass is fixed between an L-shaped short side of the metal side frame and the middle frame.

In an embodiment of the present application, the metal frame is an integrally formed structure.

In an embodiment of the present application, the metal side frame further includes an electrophoresis treated layer.

In an embodiment of the present application, the metal side frame includes a steel plate having a thickness of 0.6 mm.

In a specific embodiment of the present application, the middle frame is fixed to the side wall of the rear shell by means of a snap-fit structure.

An embodiment of the present application provides a fixing frame of a display device, including: a middle frame, a rear shell and a side frame, the side frame and the rear shell forming an integral structure, the integral structure and the middle frame fixing a liquid crystal glass; wherein

the side frame is a metal side frame, the metal side frame having an L-shaped cross section, an L-shaped long side of the metal side frame being fixed to a side wall of the rear shell via a screw to form a detachable integral structure; and

the middle frame is fixed to the side wall of the rear shell, and the liquid crystal glass is fixed between an L-shaped short side of the metal side frame and the middle frame.

In an embodiment of the present application, the metal frame is an integrally formed structure.

In an embodiment of the present application, the metal side frame further includes an electrophoresis treated layer.

In an embodiment of the present application, the metal frame is an integrally formed structure.

In an embodiment of the present application, the middle frame is fixed to the side wall of the rear shell by means of a snap-fit structure.

According to the above technical solutions according to the embodiments of the present application, an L-shaped long side of the metal side frame having an L-shaped cross section is fixed to a side wall of the rear shell via a screw to form a detachable integral structure, the middle frame is fixed to the side wall of the rear shell, the liquid crystal glass is fixed between an L-shaped short side of the metal frame and the middle frame. As such, the front side of the metal frame is capable of fixing the liquid crystal glass, and serving as an appearance surface, such that a side face is an appearance surface. According to the embodiment of the present application, the side frame may be designed to be narrower and more sightly and secure while the strength thereof is ensured.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a schematic sectional diagram of a position where a metal side frame and a rear shell screw of a display device are fixed according to an embodiment of the present application;

FIG. 2 is a schematic sectional diagram of a snap-fit structure between a middle frame and a rear shell of a display device according to an embodiment of the present application;

FIG. 3 is a schematic diagram of a display device according to an embodiment of the present application; and

FIG. 4 is an enlarged diagram of a corner of a fixing frame of a display device according to an embodiment of the present application.

### DETAILED DESCRIPTION

Some exemplary embodiments of the present application are hereinafter described in detail with reference to the accompanying drawings. Although the accompanying drawings illustrate the exemplary embodiments of the present application, it shall be understood that the present application may be practiced in various manners, and the present application shall not be limited by the embodiments illustrated herein. On the contrary, these embodiments are described herein only for the purpose of better understanding the present application, and may integrally convey the scope of the present application to a person skilled in the art.

### Embodiment 1

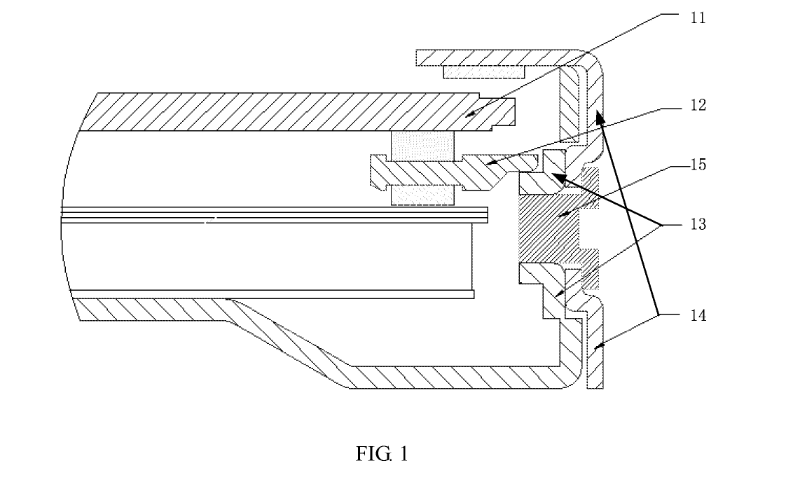

Referring to FIG. 1, a embodiment of the present application provides a display device, including: a crystal liquid glass 11, a middle frame 12, a rear shell 12 and a side frame 14; wherein the side frame 14 and the rear shell 13 form an integral structure. The integral structure and the middle frame 12 fix the liquid crystal glass 11.

The side frame 14 is a metal side frame, the metal side frame 14 has an L-shaped cross section, and an L-shaped long side of the metal side frame is fixed to a side wall of the rear shell 13 via a screw 15 to form a detachable integrated structure.

As such, the front side of the metal frame is capable of fixing the liquid crystal glass and serving as an appearance surface, such that a side face is an appearance surface. According to the embodiment of the present application, the side frame may be designed to be narrower and more sightly and secure while the strength thereof is ensured.

### Embodiment 2

The middle frame 12 is fixed to the side wall of the rear shell 13, and the liquid crystal glass 11 is fixed between an L-shaped short side of the metal side frame 14 and the middle frame 12.

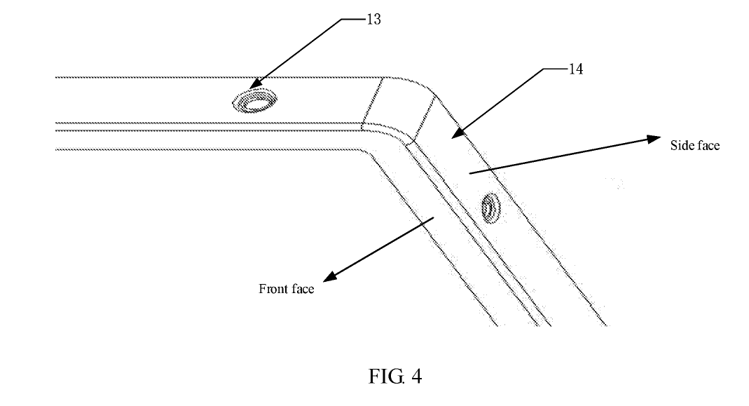

Referring to FIG. 3 and FIG. 4, according to the embodiment of the present application, the front side of the metal frame is capable of fixing the liquid crystal glass and serving as an appearance surface, such that a side face is an appearance surface. According to the embodiment of the present application, the side frame may be designed to be narrower and more sightly and secure while the strength thereof is ensured.

To be specific, to provide a more sightly appearance and simplify the fabrication process, the metal side frame 14 is an integral structure.

In addition, to provide a more sightly appearance, the metal frame 14 further includes an electrophoresis treated layer on the surface thereof.

In a specific implementation of Embodiment 1 of the present application, the process cost is lowered while the strength is ensured, and the metal frame 14 includes a steel plate having a thickness of 0.6 mm.

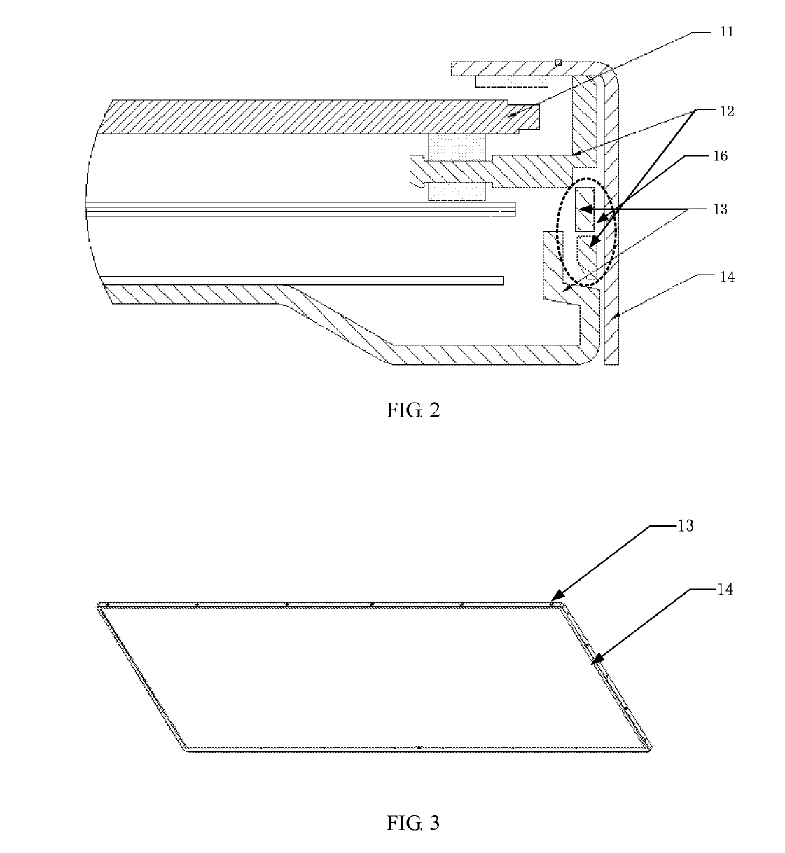

Referring to FIG. 2, since the snap-fit structure is a customary coupling manner, the middle frame 12 is fixed to a side wall of the rear shell 13 by means of a snap-fit structure 16, which simplifies the fabrication process.

Referring to FIG. 1, a specific embodiment of the present application provides a fixing frame of a display device, including: a middle frame 12, a rear shell 12 and a side frame 14; wherein the side frame 14 and the rear shell 13 form an integral structure. The integral structure and the middle frame 12 fix a liquid crystal glass 11.

The side frame 14 is a metal side frame, the metal side frame 14 has an L-shaped cross section, and an L-shaped long side of the metal side frame is fixed to a side wall of the rear shell 13 via a screw 15 to form a detachable integrated structure.

The middle frame 12 is fixed to the side wall of the rear shell 13, and the liquid crystal glass 11 is fixed between an L-shaped short side of the metal side frame 14 and the middle frame 12.

Referring to FIG. 3 and FIG. 4, according to the embodiment of the present application, the front side of the metal frame is capable of fixing the liquid crystal glass and serving as an appearance surface, such that a side face is an appearance surface. According to the embodiment of the present application, the side frame may be designed to be narrower and more sightly and secure while the strength thereof is ensured.

To be specific, to provide a more sightly appearance effect and simplify the fabrication process, the metal side frame 14 is an integral structure.

In addition, to provide a more sightly appearance, the metal frame 14 further includes an electrophoresis treated layer on the surface thereof.

In a specific implementation of Embodiment 1 of the present application, the process cost is lowered while the strength is ensured, and the metal frame 14 includes a steel plate having a thickness of 0.6 mm.

Referring to FIG. 2, since the snap-fit structure is a customary coupling manner, the middle frame 12 is fixed to a side wall of the rear shell 13 by means of a snap-fit structure 16, which simplifies the fabrication process.

In the specification provided herein, a plenty of particular details are described. However, it can be appreciated that an embodiment of the present application may also be practiced without these particular details. In some embodiments, well known methods, structures and technologies are not illustrated in detail so as not to obscure the understanding of the specification.

Likewise, it shall be understood that, to streamline the present application and facilitate understanding of one or more of various aspects of the present application, in the above description of the exemplary embodiments of the present application, various features of the present application are sometimes incorporated in an individual embodiment, drawing or description thereof. However, the method according to the present application shall not be explained to embody the following intension: the present application seeking protection claims more features than those explicitly disclosed in each of the appended claims. To be more exact, as embodied in the appended claims, the inventive aspects lie in that fewer features than all the features embodied in an individual embodiment as described above. Therefore, the claims observing the specific embodiments are herein incorporated into the specific embodiments, and each claim may be deemed as an individual embodiment of the present application.

Those skilled in the art should understand that modules in the devices according to the embodiments may be adaptively modified and these modules may be configured in one or more devices different from the embodiments herein. Modules or units or components in the embodiments may be combined into a single module or unit or component, and additionally these modules, units or components may be practiced in a plurality of submodules, subunits or subcomponents. Besides that such features and/or processes or at least some of the units are mutually exclusive, all the features disclosed in this specification (including the appended claims, abstract and accompanying drawings) and all the processes or units in such disclosed methods or devices may be combined in any way. Unless otherwise stated, each of the features disclosed in this specification (including the appended claims, abstract and accompanying drawings) may be replaced by a provided same, equivalent or similar substitution.

In addition, those skilled in the art shall understand that, although some embodiments described herein include some features included in other embodiments, rather than other features, a combination of the features in different embodiments signifies that the features are within the scope of the present application and different embodiments may be derived. For example, in the claims appended hereinafter, any one of the embodiments seeking protection may be practiced in any combination manner.

Reference herein to “one embodiment”, “an embodiment” or to “one or more embodiments” implies that a particular feature, structure, or characteristic described in connection with the embodiments is included in at least one embodiment of the present application. Further, it should be noted that instances of the phrase “in one embodiment” herein are not necessarily all referring to the same embodiment.

In the specification provided herein, a plenty of particular details are described. However, it can be appreciated that an embodiment of the present application may also be practiced without these particular details. In some embodiments, well known methods, structures and technologies are not illustrated in detail so as not to obscure the understanding of the specification.

It should be noted that the above embodiments illustrate rather than limit the present application, and those skilled in the art may design alternative embodiments without departing from the scope of the appended claims. In the claims, any reference sign placed between the parentheses shall not be construed as a limitation to a claim. The word “includes ” does not exclude the presence of an element or a step not listed in a claim. The word “a” or “an” preceding an element does not exclude the presence of a plurality of such elements. The present application may be implemented by means of a hardware including several distinct elements and by means of a suitably programmed computer. In a unit claim enumerating several devices, several of the devices may be embodied by one and the same hardware item. Use of the words “first”, “second”, “third” and the like does not mean any ordering. Such words may be construed as naming.

What is claimed is:

1. A display device, comprising: a liquid crystal glass, a middle frame, a rear shell and a side frame, the side frame and the rear shell forming an integral structure, the integral structure and the middle frame fixing the liquid crystal glass; wherein
the side frame is a metal side frame, the metal side frame has an L-shaped cross section, an L-shaped long side of the metal side frame is fixed to a side wall of the rear shell via a screw to form a detachable integral structure; and
the middle frame is fixed to the side wall of the rear shell, and the liquid crystal glass is fixed between an L-shaped short side of the metal side frame and the middle frame.

2. The display device according to claim 1, wherein the metal frame is an integrally formed structure.

3. The display device according to claims 1, wherein the metal side frame further comprises an electrophoresis treated layer.

4. The display device according to claims 1, wherein the metal side frame comprises a steel plate having a thickness of 0.6 mm.

5. The display device according to claims 1, wherein the middle frame is fixed to the side wall of the rear shell by means of a snap-fit structure.

6. A fixing frame of a display device, comprising: a middle frame, a rear shell and a side frame, the side frame and the rear shell forming an integral structure, the integral structure and the middle frame fixing a liquid crystal glass; wherein
the side frame is a metal side frame, the metal side frame has an L-shaped cross section, an L-shaped long side of the metal side frame is fixed to a side wall of the rear shell via a screw to form a detachable integral structure; and
the middle frame is fixed to the side wall of the rear shell, and the liquid crystal glass is fixed between an L-shaped short side of the metal side frame and the middle frame.

7. The fixing frame according to claim 6, wherein the metal frame is an integrally formed structure.

8. The fixing frame according to claims 6, wherein the metal side frame further comprises an electrophoresis treated layer.

9. The fixing frame according to claims 6, wherein the metal side frame comprises a steel plate having a thickness of 0.6 mm.

10. The fixing frame according to claims 6, wherein the middle frame is fixed to the side wall of the rear shell by means of a snap-fit structure.
